(19) United States
(12) Patent Application Publication
(10) Pub. No.: US 2023/0231395 A1
(43) Pub. Date: Jul. 20, 2023

(54) BATTERY SYSTEM

(71) Applicant: BLACK & DECKER INC., Towson, MD (US)

(72) Inventors: MATTHEW J. VELDERMAN, Baltimore, MD (US); Daniel J. White, Baltimore, MD (US)

(21) Appl. No.: 18/125,376

(22) Filed: Mar. 23, 2023

Related U.S. Application Data
(62) Division of application No. 16/400,537, filed on May 1, 2019.
Application No. 16/400,537 is a continuation of application No. PCT/US2017/060181, filed on Nov. 6, 2017.
(60) Provisional application No. 62/417,759, filed on Nov. 4, 2016.

(51) Int. Cl. H02J 7/00; B60R 16/04; H01M 50/244; H01M 50/247

(52) U.S. Cl. CPC H02J 7/0045; B60R 16/04; H01M 50/244; H01M 50/247; H01M 2220/30

(57) ABSTRACT

A battery system including a removable battery pack, including a plurality of battery cells and an interface for electrically and mechanically coupling to a load bearing device; a vehicle, including a power station for providing power to drive the vehicle, the power station including a port for accepting the removable battery pack; and a power tool including a port for accepting the removable battery pack.

### RELATED APPLICATIONS

This application is a divisional of and claims priority to U.S. Pat. Application No. 16/400,537, filed May 1, 2019, which is a continuation of and claims priority to PCT Application No. US2017/060181, filed Nov. 6, 2017, which claims priority to U.S. Provisional Pat. Application No. 62/417,759, filed Nov. 4, 2016, titled “Battery System” which is incorporated herein by reference.

### TECHNICAL FIELD

This application relates to a system and method for a battery system for use in automotive and residential applications. In one implementation, the system includes a rechargeable and removable battery pack, also referred to as a power module, that is transferable between and connectable to a plurality and variety of vehicles, power tools and equipment and residential and/or commercial buildings.

### BACKGROUND

There is a growing market prevalence of electric vehicles (EVs) and hybrid electric vehicles (HEVs). The batteries in these vehicles are being considered as energy sources for other applications, such as vehicle to grid energy arbitrage, to get the most utility out of the batteries. Having multiple uses for these high energy, high power, and high cost batteries increases their value proposition with competing technologies.

EV/HEV batteries are primarily single function (i.e. to power the vehicle) and fixed (i.e. non-removable) energy sources. The expandability and additional utility outside of the EV/HEV is limited.

### BRIEF DESCRIPTION OF THE DRAWINGS

FIG. 1 illustrates an exemplary feature of an automotive portion of an exemplary battery system of the present disclosure.

FIG. 2 illustrates another exemplary feature of an automotive portion of the exemplary battery system of the present disclosure.

FIG. 3 illustrates another exemplary feature of an automotive portion of the exemplary battery system of the present disclosure.

FIG. 4 illustrates another exemplary feature of an automotive portion of the exemplary battery system of the present disclosure.

FIG. 5 illustrates another exemplary feature of an automotive portion of the exemplary battery system of the present disclosure.

FIG. 6 illustrates an exemplary implementation of the exemplary feature illustrated in FIG. 5.

FIG. 7 illustrates various exemplary features of an automotive portion of the exemplary battery system of the present disclosure.

FIG. 8 illustrates an exemplary feature of a cross automotive-tool portion of the exemplary battery system of the present disclosure.

FIG. 9 illustrates an exemplary feature of a cross automotive-building portion of the exemplary battery system of the present disclosure.

FIG. 10 illustrates an exemplary feature of a building portion of the exemplary battery system of the present disclosure.

FIG. 11 illustrates another exemplary feature of a cross automotive-building portion of the exemplary battery system of the present disclosure.

FIG. 12 illustrates an exemplary feature of an outdoor activities portion of the exemplary battery system of the present disclosure.

### DETAILED DESCRIPTION

An electric vehicle (EV) or hybrid electric vehicle (HEV) may be equipped with a vehicle power station 50 having one or more ports (i.e. rails, terminals, housing, electronics) for receiving removable batteries 52 (also referred to as power modules).

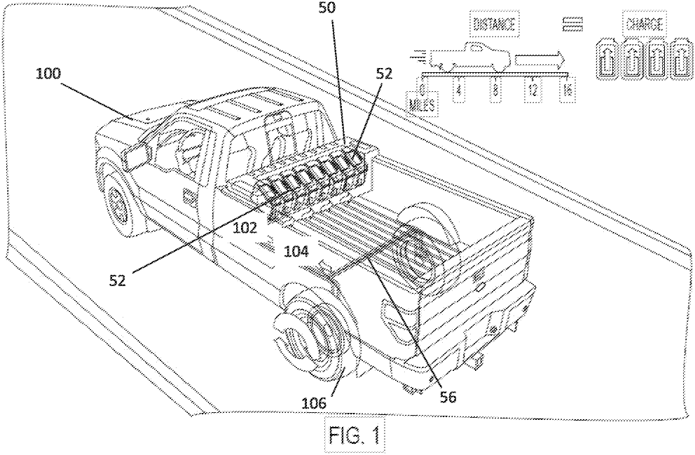

Referring to FIG. 1, in an exemplary embodiment, an automotive portion of a battery system is disclosed. FIG. 1 illustrates an exemplary electric vehicle 100. In this embodiment, the vehicle 100 is a pickup truck. Other types of vehicles, such as cars, sport utility vehicles, and buses, are encompassed by the present invention. The electric vehicle 100 includes a primary drive vehicle battery 102 and an electric motor 104 electrically coupled to the vehicle battery 102 and the driven vehicle wheels 106, as is well known in the art. The vehicle 100 may also be a hybrid electric vehicle that includes an internal combustion engine 108, which either supplements the vehicle battery 102 or is supplemented by the vehicle battery 102 to provide a motive force to the driven wheels 106. The battery system includes a vehicle power station 50. The power station 50 may be originally designed, built and integrated to the electric vehicle 100 or it may be installed on the vehicle 100 as an aftermarket component after the electric vehicle 100 leaves the factory. The vehicle power station 50 includes at least one port 54 (also referred to as a receptacle) for receiving a power module 52 (also referred to as a battery pack). Each vehicle power station port 54 includes an interface for electrically and mechanically coupling to the power module 52. Each power module 52 includes an interface for electrically and mechanically coupling to the interface of the port 54 of the vehicle power station 50. The power modules 52 connect into the electrical system 56 of the electric vehicle 100 through the vehicle power station 50. The vehicle power station 50 is electrically coupled to the vehicle battery 52. The vehicle power station 50 may also be electrically coupled to the vehicle motor 104. The vehicle power station 50 may also include a control module 58 to control charging and discharging of the power modules 52, as discussed in more detail below.

As illustrated in FIG. 1, the vehicle battery 102 may charge one or more of the power modules 52 in the vehicle power station 50.

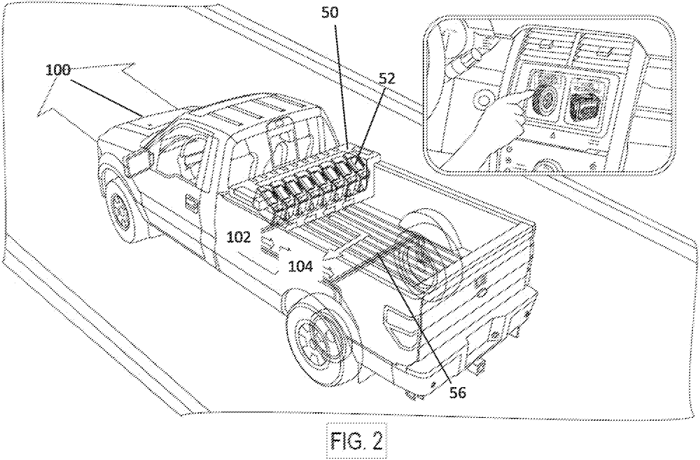

Referring also to FIG. 2, the vehicle power station 50 may discharge one or more of the power modules 52 into the vehicle electrical system 56 to increase the electric vehicle’s range and/or performance. More specifically, the vehicle user places the battery system in a “charge mode” which will draw energy from the electric vehicle system (vehicle battery 100) and transfer it into the power models 52 or select from a number of options which draw energy from the power modules 52 and supply the energy to the vehicle system 100. For example, the battery system may include a fuel economy mode which increases the range on pure electric or electric assist or a power boost (performance) mode which uses the additional current delivery capability of the power modules 52. Through the operation of an in-car interface, the user can select the fuel economy mode or the boost mode and determine how the energy from the power modules 52 will be deployed. As such, the power modules 52 may supplement the vehicle battery 102 to provide extended range or increased performance. In this instance, the power modules 52 may provide energy to the vehicle motor 104 through the vehicle battery 102 or directly to the vehicle motor 104. Alternatively, the power modules 52 may be used as a backup power source and only used when the vehicle battery 102 is fully depleted. In this case, the power modules 52 remain fully charged unless the vehicle battery 102 is fully depleted and the power modules 52 may be used for other purposes, as described below. In such an instance, the power modules 52 may provide power directly to the vehicle motor 104. Alternatively, the power modules 52 may simply charge the vehicle battery 102 but not drive the vehicle motor 104.

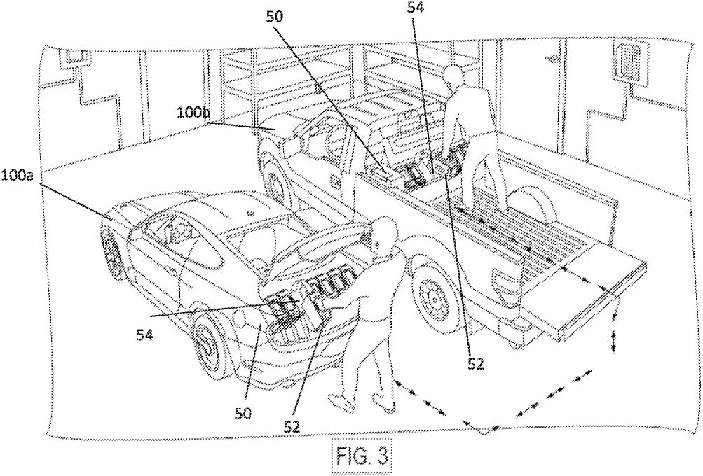

Referring to FIG. 3, another feature of the battery system is that the power modules 52 may be transferred between multiple vehicles 100a, 100b, wherein each vehicle includes a vehicle power station 50. As illustrated, the power modules 52 may be transferred between the electric pickup truck 100b and an electric or hybrid electric car 100a. The power modules 52 may have a variety of different configurations such as high capacity versions, high power versions, super capacitor extreme performance versions and fuel cell range extending versions, as well as internal combustion engine power generating versions. Each power module 52 configuration will include an interface to allow it to be connected into the electrical system of the electric vehicle 100 through the vehicle power station 50.

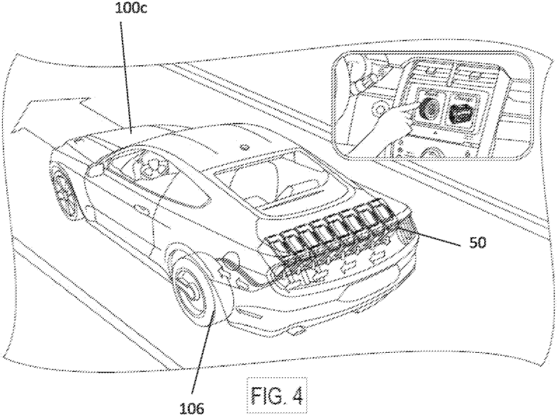

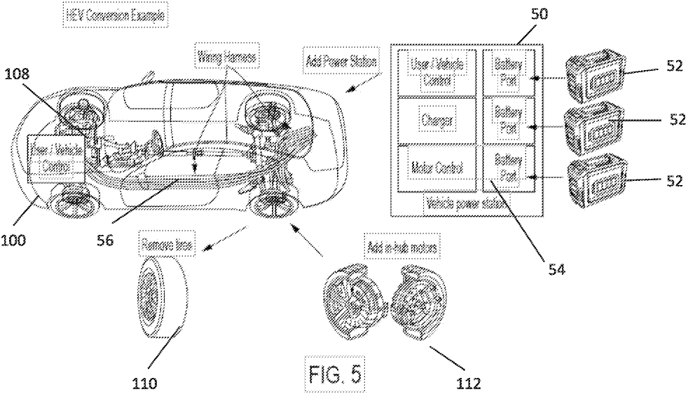

Referring to FIGS. 4 and 5, another feature of the battery system is that an internal combustion engine (ICE) vehicle 100c may be converted to a hybrid electric vehicle or a pure electric vehicle. As illustrated in FIG. 4, a vehicle power station 50 is installed in a trunk of the ICE vehicle 100c and coupled to the driven wheels 106 of the vehicle 100c. As illustrated in FIG. 5, the original vehicle wheels/tires 110 are removed and replaced with wheels/tires with in-hub motors 112. The vehicle power station 50 is electrically coupled to the in-hub motors 112. As such, when desired, the power modules 52 may provide power to the in-hub motors 112 to drive the vehicle 100c. The vehicle 100c may also use the original internal combustion engine 108 to drive the driven wheels 112 alone or in conjunction with the energy from the power modules 52. This system will provide the converted vehicle with either increased performance or increased range. This may also provide a backup system if the ICE 108 breaks down or runs out of fuel.

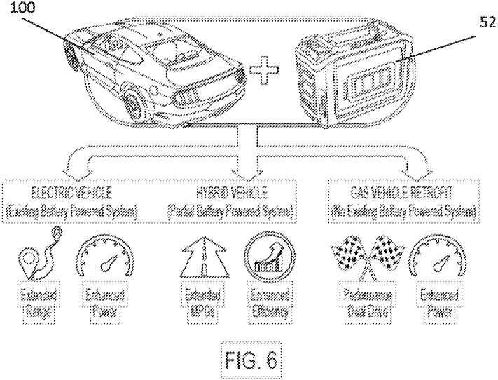

Referring to FIG. 6, illustrates the various benefits of having supplemental or auxiliary power through the use of add-on power modules 52 and a vehicle power station 50 in an electric, hybrid electric or gasoline vehicle.

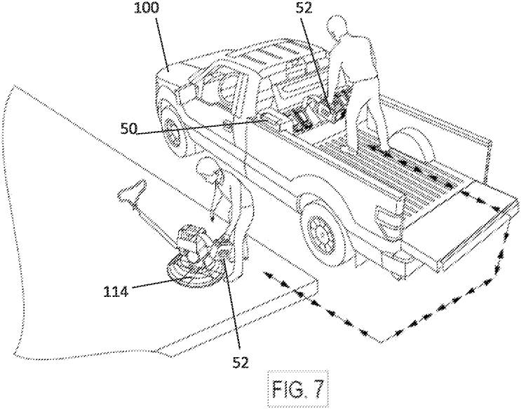

Referring to FIG. 7, another feature of the battery system is that the power modules 52 may be transferred between the electric vehicle 100 and a power tool 114 (e.g. concrete saw, power trowel), or power equipment 116 (e.g. lawn mowers, fork lifts, inverters), or other vehicles 118 (e.g. motorcycle, UTV) (collectively, device) that includes a port having an electrical and mechanical interface to accept the power module 52. The user may remove the power module 52 from the electric vehicle 100 and plug it into the device 114 and vice versa as long as both the vehicle 100 and the device 114 are equipped with an interface designed to mechanically and electrically couple to the power module 52.

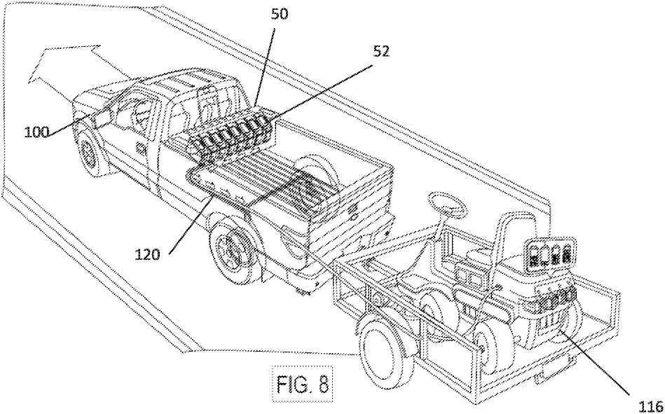

Referring to FIG. 8, another feature of the battery system is that the power modules 52, through the vehicle power station 50, may power a vehicle or equipment towed or otherwise associated with the electric vehicle 100. For example, as illustrated in FIG. 8, a trailer 118 carrying a lawn mower 116 is mechanically coupled to the electric vehicle 100 (pickup truck) so that the electric vehicle 100 can transport the trailer 118 from location to location. The vehicle power station 50 may be coupled to the lawn mower 116 through a power cord 120 to discharge energy from the power modules 52 to battery packs on the lawn mower 116. Alternatively, the recreational vehicle may be mechanically coupled to the electric vehicle and the vehicle power station 50 may provide energy to the various loads/appliances in the RV, either through a power cord or through the hitching mechanism.

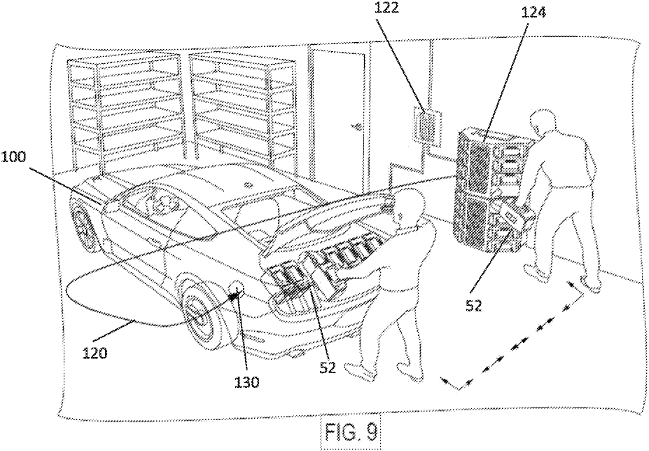

Referring to FIG. 9, another feature of the battery system is that the power modules/battery packs 52 can be used as part of a residential or commercial electrical system 122. In the case of a residential or home electrical system, the system may include a home power station 124. The home power station 124 includes a plurality of ports 126 for receiving the power modules 52. The home power station 124 may be coupled to the home electrical system. As such, (1) the power modules 52 — through the home power station 124 — may receive power from the utility system (through the home electrical system) to charge the power modules 52 or (2) the power modules 52 — through the home power station 124 — may provide power to the home electrical system to power various appliances, tools, etc. plugged into the home electrical system or even provide power back to the utility grid, for example, when utility grid power costs are high. The power modules 52 may be transferred from the electric vehicle 100 to the home power station 124 for charging or discharging through the home power station 124. Alternatively, the home power station 124 can be coupled to the vehicle 100 to charge the power modules 52 in the vehicle power station 50, either from power modules 52 in the home power station 124 or from the utility grid. Alternatively, the home power station 124 may be coupled to the electric vehicle 100 (with or without a vehicle power station) to power the vehicle battery 102. The home power station 124 may include a control module to monitor and control the charging and discharging of the power modules 52. The home power station 124 may also include a communication system to communicate with a homeowner regarding the status of the power modules and any device coupled to the home power station.

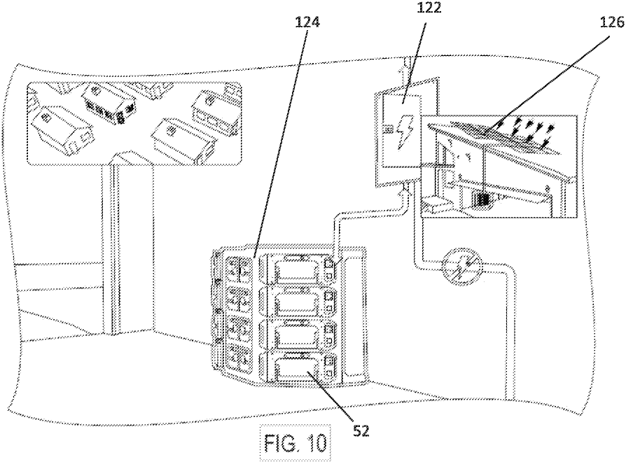

Referring to FIG. 10, another feature of the battery system is that the home power station 124 may be coupled to a photovoltaic solar system 126. As such, the solar system 126 may charge the power modules 52 in the home power station 124. This may occur whether or not the utility grid is available to charge power modules 52. Alternatively, the solar system 126 can charge the power modules 52 when possible (the sun is shining) either primarily (charging the power modules 52 as a higher priority than providing power to the home electrical grid to power home appliances) or secondarily (charging the power modules 52 as a lower priority than providing power to the home electrical grid to power home appliances) and the power modules 52 can discharge to the home electrical grid when the sun is not shining or when power from the utility grid is selling for a relatively high cost. The home power station 124 can also serve as a backup system when the utility grid is not available and/or the sun is not shining. Alternatively, the home includes a home power station 124 but not a solar system, the home power station 124 could charge the power modules 52 from the utility grid when utility grid power is relatively inexpensive (during off peak hours, e.g., at night) and discharge the power modules 52 to the home electrical grid to power home appliances or back to the utility grid when utility grid power is relatively expensive (during peak hours).

Additionally, using the electric vehicle’s main charging port, the electric vehicle 100 may be electrically coupled to the home power station 124 to charge the vehicle battery 102 and/or the power modules 52 from energy generated by the solar system 126. This solar system energy may be used to charge the vehicle battery 102 or the power modules 52 directly or from energy generated by the solar system 126 that is stored in power modules 52 in the home power station 124. In addition, the battery system may be used to arbitrage energy. More specifically, the home power station 124 may draw energy from the utility grid when utility energy prices are low and store the energy in the power modules and return/sell the energy to the utility grid when utility energy prices are high. Alternatively, the home power station 124 may (1) draw energy from the solar system 126 and provide power to the home loads and/or sell excess energy to the utility grid when the when utility prices are high and (2) draw energy from the utility grid and store energy from the solar system 126 in the power modules 52 when utility energy prices are low.

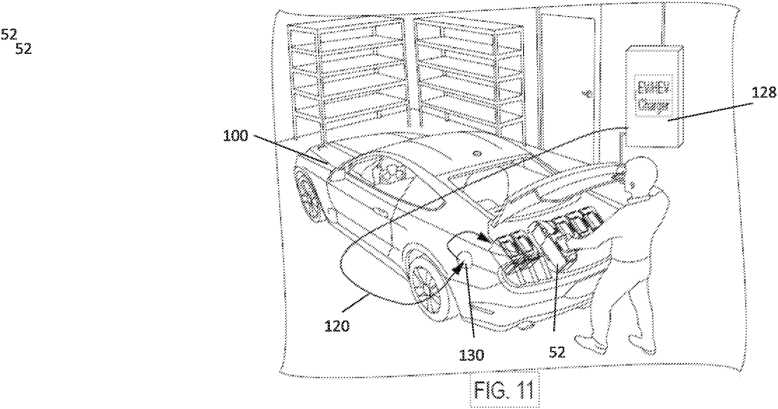

Referring to FIG. 11, the electric vehicle 100 may be coupled to an electric vehicle charger 128 in the home (or outside of the home) through the vehicle’s main charging port130 to charge the power modules 52 in addition to charging the vehicle battery 102.

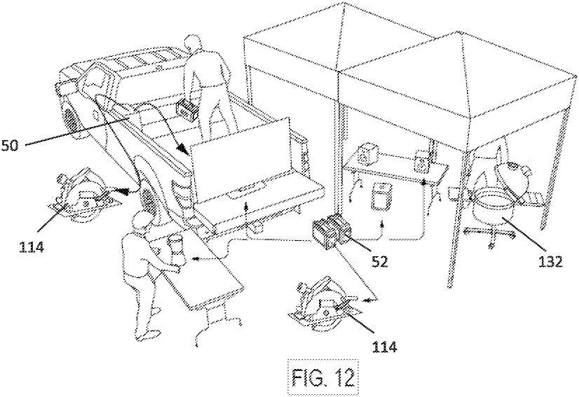

Referring to FIG. 12, the power modules/battery packs 52 can be removed and used to supply power not only to power equipment 114, 116 used in construction or industry, such as circular saws but also for leisure appliances such as blenders, televisions, speakers, and electric grills. Alternatively, the power modules/battery packs 52 installed in the auxiliary power station can provide power to auxiliary devices such as AC products (e.g. microwaves, stereos), high voltage DC products (e.g. power tools, equipment), or low voltage DC products (e.g. phone chargers, jump starters) through an interface on the auxiliary power station.

The battery system may report information about the condition of the power modules (e.g. state of charge, cycles, temperature) directly to the user, through the vehicle’s display system, through the home power station, or through connected devices (e.g. smart phone).

The power modules may provide power directly to the home through the use of an inverter, which may be integrated as part of the home power station.

The power modules may be substantially the same working voltage as the vehicle’s electrical system.

The power modules and/or the vehicle power station and/or the home power station may include electronics for the safe removal and connection of the power modules from/to the vehicle’s or home’s electrical system.

### Advantages

Advantages of this system include Increased vehicle power, increased vehicle runtime, a scalable and expandable system, the ability to use battery packs to power the system and for power tools, power equipment, and home energy needs.

Numerous modifications may be made to the exemplary implementations described above. These and other implementations are within the scope of this application.

1. A battery system, comprising:
a removable battery pack, including a plurality of battery cells and an interface for electrically and mechanically coupling to a load bearing device;
a vehicle, including a power station for providing power to drive the vehicle, the power station including a port for accepting the removable battery pack; and
a power tool including a port for accepting the removable battery pack.

2. The battery system, as recited in claim 1, wherein the power station port comprises an electrical and mechanical interface for coupling the removable battery pack to the power station.

3. The battery system, as recited in claim 1, wherein the power tool comprises an electrical and mechanical interface for coupling the removable battery pack to the power tool.

4. The battery system, as recited in claim 1, wherein the power station port comprises an electrical and mechanical interface for coupling the removable battery pack to the power station and wherein the power tool comprises an electrical and mechanical interface for coupling the removable battery pack to the power tool, wherein the power station interface is substantially identical to the power tool interface.

5. The battery system, as recited in claim 1, further comprising a towed vehicle coupled to the vehicle, wherein the power station is electrically coupled to the towed vehicle to charge various loads of the towed vehicle or an internal battery of the towed vehicle.

6. The battery system, as recited in claim 5, wherein the towed vehicle is a trailer and wherein the power tool is a lawn mower carried by the trailer and wherein the power station is electrically coupled to the lawn mower to charge an internal battery of the lawn mower and/or a removable battery pack in the lawn mower port.
